(19) United States
(12) Patent Application Publication
(10) Pub. No.: US 2023/0025393 A1
(43) Pub. Date: Jan. 26, 2023

(54) METHOD FOR ADJUSTING A MOTOR TORQUE OF A MOTOR OF AN ELECTRIC BICYCLE AND ASSOCIATED DEVICE FOR ADJUSTING A MOTOR TORQUE

(71) Applicant: Robert Bosch GmbH, Stuttgart (DE)

(72) Inventor: Joseph Reck, Filderstadt (DE)

(21) Appl. No.: 17/869,403

(22) Filed: Jul. 20, 2022

(30) Foreign Application Priority Data
Jul. 26, 2021 (DE) 10 2021 208 022.7

(51) Int. Cl. B60L 15/20

(52) U.S. Cl. CPC B60L 15/20; B60L 2240/12; B60L 2240/14; B60L 2240/423

(57) ABSTRACT

A method for adjusting a motor torque of a motor of an electric bicycle. The method includes a detection of a speed signal, which describes a speed of the bicycle, a selection of a filter parameter for a filter unit based on a dynamics of the speed signal, a filtering of the speed signal by the filter unit by applying the selected filter parameter, and an ascertainment of a motor torque based on the filtered speed signal. An associated device is also described.

### CROSS REFERENCE

The present application claims the benefit under 35 U.S.C. § 119 of German Patent Application No. DE 10 2021 208 022.7 filed on Jul. 26, 2021, which is expressly incorporated herein by reference in its entirety.

### FIELD

The present invention relates to a method and to a device for adjusting a motor torque of a motor of an electric bicycle.

### BACKGROUND INFORMATION

Due to regulatory requirements, motor assistance in pedelecs is permissible only up to a certain speed. This is maintained in that the motor assistance is reduced in linear fashion starting at a certain speed. The limit speed, starting at which the motor assistance is reduced, is normally the regulatory value plus a tolerance. The motor torque is calculated in simplified terms from a rider torque, an assistance factor and the factor of the speed cut-off.

The assistance factor is typically defined by way of an assistance characteristic curve, which indicates the assistance factor across possible speeds. This assistance characteristic curve typically features a ramp, by which the assistance factor near the limit speed is regulated downward. For this purpose, the rising ramp must produce a compromise between two requirements. On the one hand, if possible, a maximum assistance is to be achieved up to the cut-off limit, which means that a steep ramp is desirable. On the other hand, no abrupt stop of the assistance should be noticeable, which means that a gentle ramp is likewise desirable.

The steeper the ramp, the more noticeable are small fluctuations in the speed signal, since these affect the motor assistance directly. Fluctuations in the speed signal can always occur. On the one hand, the speed measurement in pedelecs is not particularly precise. This is due, for example, to the sensor system used, such as reed sensors, for example, which calculate the speed signal from pulses. For constructional reasons, such pulses are usually available only once per wheel revolution. On the other hand, the real speed always fluctuates in a certain range even in uniform environmental conditions and uniform pedal motion on the part of the rider.

The varying motor assistance due to the varying measured speed is generally perceived as uncomfortable by a rider of the bicycle.

### SUMMARY

A method according to an example embodiment of the present invention for adjusting a motor torque of a motor of an electric bicycle comprises a detection of a speed signal, which describes a speed of the bicycle, a selection of a filter parameter for a filter unit based on dynamics of the speed signal, a filtering of the speed signal by the filter unit by applying the selected filter parameter and an ascertainment of a motor torque based on the filtered speed signal.

A device according to an example embodiment of the present invention for adjusting a motor torque of a motor of an electric bicycle is designed to carry out the following steps: detecting a speed signal, which describes a speed of the bicycle, selecting a filter parameter for a filter unit based on dynamics of the speed signal, filtering the speed signal by the filter unit by applying the selected filter parameter and ascertaining a motor torque based on the filtered speed signal.

The ascertained motor torque is in this case in particular a maximum motor torque, which is provided for assisting a rider of the bicycle. The ascertained motor torque is thus not necessarily actually provided by the motor, but is available, if it is required for assisting the rider and the bicycle, for example when this is indicated by a rider torque. The rider torque is here a torque exerted by the rider of the bicycle on the pedals of the bicycle. Alternatively, the ascertained motor torque is a motor torque that is provided in response to the ascertainment of the motor torque by the motor.

A speed signal is detected that describes a speed of the bicycle. The detection of the speed signal occurs preferably by a sensor situated on the bicycle. The speed signal is thus detected for example by a reed sensor. The speed signal is preferably a signal, whose signal value rises with a rising speed of the bicycle and whose signal value falls with a falling speed of the bicycle.

A filter parameter is selected for a filter unit, based on a dynamics of the speed signal. In accordance with an example embodiment of the present invention, for this purpose, typically a value for a specific filter parameter is selected. The dynamics of the speed signal is a parameter, which indicates a variability of the speed signal. Thus, the dynamics of the speed signal is in particular zero when the speed signal is constant. The dynamics of the speed signal is described in particular by a gradient of the speed signal over its time characteristic. The filter parameter for the filter unit is selected on the basis of the dynamics. Thus, the filter parameter is adapted in particular in response to a change of the dynamics of the speed signal. Different dynamics of the speed signal thus result in different values for the filter parameter. In selecting the filter parameter, a value for a parameter is thus chosen, which is supplied to the filter unit. A filter characteristic of the filter unit is accordingly adapted to the filter parameter.

The speed signal is filtered by the filter unit by applying the selected filter parameter. The speed signal is thus filtered as a function of a dynamics of the speed signal. The filtering of the speed signal produces the filtered speed signal.

In accordance with an example embodiment of the present invention, a motor torque is ascertained on the basis of the filtered speed signal. The motor torque is in this case in particular a maximally provided motor torque. The motor torque is thus not produced directly from the speed signal, but rather based on the filtered speed signal. For this purpose, for example, a plurality of possible values of the speed signal are each assigned an associated motor torque. In accordance with this assignment, the motor torque is ascertained from the filtered speed signal. The motor torque is therefore ascertained indirectly based on the actual speed of the electric bicycle, but with an upstream filtering of the speed signal. Depending on the selection of the filter parameter, individual fluctuations in the actual speed of the electric bicycle may not be included in the ascertainment of the motor torque.

It is thus possible to provide a uniform assistance of the rider at the cut-off limit, even when there are slight fluctuations in the speed signal. An increased ride comfort is thus achieved, in particular during uniform travel at the cut-off limit, it being at the same time ensured that the regulatory requirements regarding the motor assistance of the rider are maintained.

Preferred developments of the present invention are disclosed herein.

The dynamics of the speed signal are preferably described by an acceleration of the bicycle. Conversely, this also means that an acceleration of the bicycle may be regarded as the dynamics of the speed signal. The acceleration of the bicycle is ascertained in particular by a derivation of the speed signal over its time characteristic. Thus, the acceleration of the bicycle may be read out from the speed signal, the acceleration describing in particular a gradient of the speed signal over time. The dynamics of the speed signal is thus preferably ascertained by calculation from the speed signal. Alternatively, the dynamics of the speed signal is ascertained independently of the speed signal. Thus, it is possible to ascertain the dynamics of the speed signal based on a sensor, for example, if the sensor describes an acceleration of the bicycle. In this case, the dynamics of the speed signal may be ascertained by an acceleration sensor.

In accordance with an example embodiment of the present invention, it is also advantageous if the filter unit comprises a low-pass filter. The filter unit is in particular a low-pass filter having adjustable filter parameters. Using low-pass filtering of the speed signal, it is thus possible to filter out in particular smaller fluctuations in the speed signal, which have a direct effect on the motor assistance. Thus, it is in particular possible to filter out also fluctuations from the speed signal that are caused by a pedaling motion of the rider.

In accordance with an example embodiment of the present invention, It may also be advantageous if the filter parameter is selected in such a way that the speed signal is filtered to a lesser degree in a first dynamics than in a second dynamics, where the first dynamics is greater than the second dynamics. This means in other words that in the case of a greater dynamics of the speed signal, the speed signal is filtered to a lesser degree than in the case of a weaker dynamics. A greater degree of filtering here means that unwanted signal components are damped to a greater degree. In this manner, it is possible to prevent a greater torque from being provided by the motor of the bicycle than is permitted for a specific speed. In particular, it is possible to prevent an exceedance of a permissible assistance by the motor above a limit speed, which may occur, for example, if a great acceleration occurs in a very dynamic speed signal, but it is filtered and the system thus falsely assumes a lower speed of the bicycle. This may be prevented in that, by reducing the degree of filtering in the event of a high dynamics, the speed signal is provided in a nearly unfiltered state and is used for ascertaining the motor torque.

Above a predefined first dynamics limit value, the filter parameter is preferably set to a minimum value, at which a, for the filter unit, minimal filtering or no filtering of the speed signal occurs. This means that the filter unit performs merely minimal filtering or no filtering when the dynamics of the speed signal, in particular the acceleration of the bicycle, is above the first dynamics limit value. By setting such a first dynamics limit value it is possible to ensure that for a high dynamics of the speed signal, no filtered speed signals are output, indicating a speed of the vehicle, which deviate from the actual speed of the vehicle. It is thus possible to ensure that no motor torque is provided when the actual speed of the vehicle is above a permissible maximum value for a motor assistance.

In accordance with an example embodiment of the present invention, it may also be advantageous if the filter parameter is selected as a function of an acceleration of the bicycle in such a way that a degree of filtering of the speed signal increases over time when the acceleration is below a second dynamics limit value and a degree of filtering of the speed signal decreases over time when the acceleration is above the second dynamics limit value. In particular during uniform rides of the bicycle, this results in a smoother speed signal and thus results in a more uniform assistance of the rider at the cut-off limit. The cut-off limit is the speed starting at which no further motor assistance of the bicycle is to occur.

It is furthermore advantageous if the first dynamics limit value corresponds to a higher acceleration than the second dynamics limit value. Thus, it is possible to ensure that above the first dynamics limit value a range is created, in which a distortion of the speed signal by filtering is excluded, and at the same time a range below the first dynamics limit value is created, in which the filter constant is able to vary dynamically, depending on whether the dynamics are above or below the second dynamics limit value.

It is also advantageous if in the ascertainment of the motor torque on the basis of the filtered speed signal, the motor torque is ascertained based on an assistance characteristic curve. The assistance characteristic curve defines the degree of the available motor torque for different speeds and defines in particular starting at what speed value a motor assistance of the rider is to be reduced. Such assistance characteristic curves are generally used in controlling electric bicycles. Thus, the method according to the present invention may also be applied to assistance characteristic curves, as already used in the related art. For this purpose, it is possible to adopt the assistance characteristic curve unchanged, which however does not preclude the assistance characteristic curve from being modified based on further methods.

The assistance characteristic curve preferably defines an assistance factor over a speed.

### BRIEF DESCRIPTION OF THE DRAWINGS

Exemplary embodiments of the present invention are described in detail below with reference to the figures.

FIG. 1 is an illustration of an electric bicycle including a device for adjusting a motor torque of a motor of the electric bicycle, in accordance with an example embodiment of the present invention.

FIG. 2 is a flow chart of a method according to an example embodiment of the present invention for adjusting a motor torque of a motor of an electric bicycle,

FIG. 3 shows a representation of an exemplary assistance characteristic curve, in accordance with an example embodiment of the present invention.

FIG. 4 shows a signal flow chart, which allows for an implementation of the method for adjusting a motor torque of a motor of a bicycle, in accordance with an example embodiment of the present invention.

### DETAILED DESCRIPTION OF EXAMPLE EMBODIMENTS

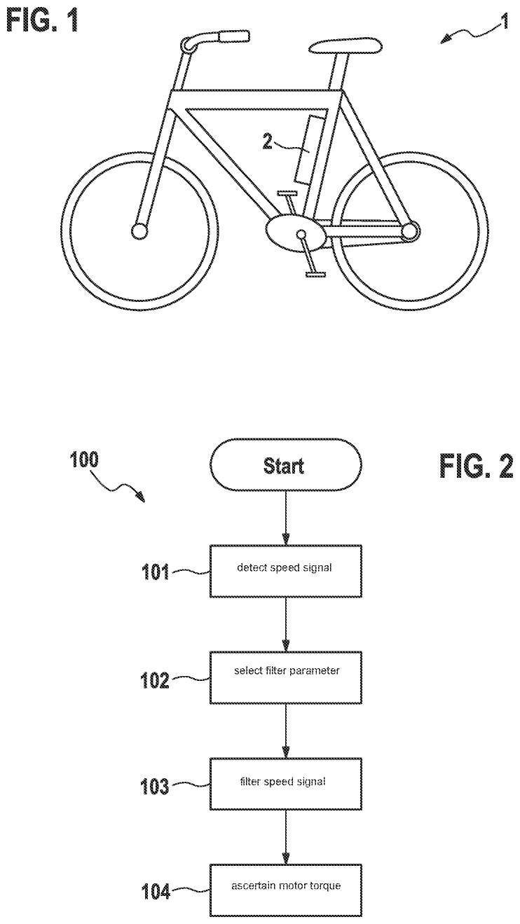

FIG. 1 shows a bicycle 1, which comprises a device 2 for adjusting a motor torque of a motor of the electric bicycle 1. The device 2 is an electronic control unit of a motor of the electric bicycle 1. Device 2 is configured to carry out the method 100 according to the present invention for adjusting a motor torque of a motor of an electric bicycle 1.

FIG. 2 shows a flow chart of the method 100 for adjusting a motor torque of a motor of the electric bicycle 1.

If method 100 is triggered, initially a first method step 101 is carried out. In the first method step 101, a speed signal 10 is detected that describes a speed of the bicycle 1. The speed signal 10 is here in particular an output signal of a speed sensor, for example of a reed sensor. Thus, speed signal 10 is for example an analog signal, which has an amplitude that describes the speed of bicycle 1. Thus, there is for example a linear relationship between the amplitude of speed signal 10 and the speed of electric bicycle 1. In alternative specific embodiments, speed signal 10 is a digital signal.

Following the performance of the first method step 101, a second method step 102 is carried out. In second method step 102, a filter parameter is selected for a filter unit 11, based on a dynamics of the speed signal. Thus, in second method step 102, at least one filter parameter T is selected or generated, which is supplied to filter unit 11. The filter unit 11 is in this specific embodiment a low-pass filter, through which the speed signal 10 is filtered. By way of filter parameter T, a filter characteristic of filter unit 11, here of the low-pass filter, is adjusted. In the process, in particular a damping value of the low-pass filter is adjusted by filter parameter T.

The dynamics of speed signal 10 are fundamentally a variability of the speed signal. In the specific embodiment described here, the dynamics of the speed signal are defined by an acceleration of the electric bicycle 1. Speed signal 10 thus rises sharply in the event of a sharp acceleration, which results in a sharp change of speed signal 10. There thus exists a high dynamics of the speed signal. It should be noted, however, that it is alternatively also possible to utilize other values describing a dynamics of the speed signal for the purpose of selecting the filter parameter. Thus, speed signals contain frequency components for example, which result from a cadence of a rider of bicycle 1. The dynamics could also be selected in such a way, for example, that they describe a variability of the frequencies of the speed signal 10.

Filter parameter T is selected in such a way that speed signal 10 is filtered to a lesser degree in the case of a first dynamics than in the case of a second dynamics, where the first dynamics is greater than the second dynamics. This has the result that speed signal 10 is filtered less in the case of a high dynamics, whereby, for example, a precise adherence to limit values in a subsequent ascertainment of a motor torque is ensured. In the specific embodiment described here, two dynamics limit values are defined, whereby a bandwidth of possible values describing the dynamics of the speed signal is subdivided into three ranges. Thus, a first dynamics limit value and a second dynamics limit value are defined. The first dynamics limit value corresponds to a higher acceleration than the second dynamics limit value.

Above the first dynamics limit value, that is, when the dynamics of the speed signal are greater than the first dynamics limit value, the filter parameter T is set to a minimum value, at which a, for the filter unit, minimal filtering or no filtering of the speed signal 10 occurs. Thus, for example, a damping of the damping range of the low-pass filter is set to zero. This corresponds to a state, in which the low-pass filter is deactivated. This ensures that at a very high dynamics of the speed signal, no change occurs in speed signal 10, before the latter is used for ascertaining the motor torque.

If the dynamics of the speed signal are between the first dynamics limit value and the second dynamics limit value, then the filter parameter T is set in such a way that it decreases over time. This ensures that a filtering of speed signal 10 is not ended abruptly, which could result in an uncomfortable sensation for the rider.

If the dynamics of speed signal 10 are below the second dynamics limit value, then a degree of the filtering of speed signal 10 rises over time. This means that over time a particularly strong filtering of speed signal 10 is achieved by the low-pass filter. It is thus ensured that especially in rides at continuous speed, a strong filtering of speed signal 10 occurs, which also entails a particularly continuous assistance of the rider, that is, a particularly continuous result in an ascertainment of the motor torque. Thus, as particularly comfortable riding experience is achieved in rides at continuous speeds.

In a third method step 103, which follows the selection of filter parameter T for filter unit 11 in the second method step 102, speed signal 10 is filtered by filter unit 11 by applying the selected filter parameter T. Speed signal 10 is thus first analyzed in order to determine a filter parameter T for filter unit 11 and is subsequently filtered accordingly by filter unit 11. In the process, the unwanted signal components are filtered out of speed signal 10. Speed signal 10 is thus provided at an input of filter unit 11. A filtered speed signal 12 is output at an output of filter unit 11.

Following the third method step 103, a fourth method step 104 is carried out. In fourth method step 104, a motor torque is ascertained on the basis of the filtered speed signal 12. For this purpose, the motor torque of the motor of the electric bicycle 1 is ascertained on the basis of an assistance characteristic curve. The assistance characteristic curve 20 defines an assistance factor S over a speed of bicycle 1.

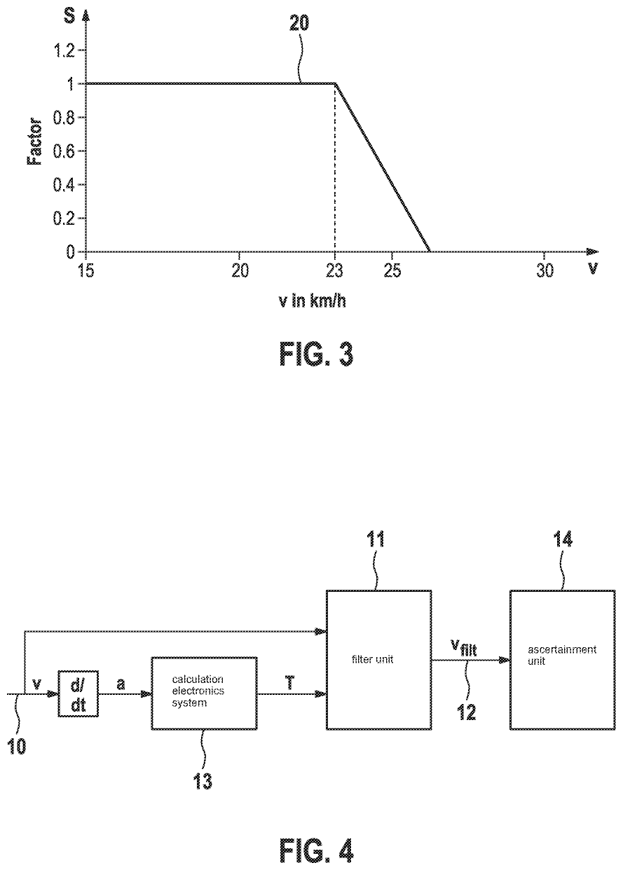

An exemplary assistance characteristic curve 20 is shown in FIG. 3. The assistance characteristic curve 20 thus defines to what degree the motor torque of the motor should assist the bicycle torque. It can be seen, for example, that in a low speed range, for example below 23 km/h, an assistance factor S of “1” should be selected. This means that a rider torque applied by the rider is multiplied by the assistance factor S of the value “1” in order to calculate the motor assistance, in particular the motor torque, to be provided. Following the exemplary limit speed of 23 km/h, assistance factor S decreases in accordance with a ramp and at a speed of approx. 26 km/h drops to the value zero. In this range, the assistance factor S drops from a value of “1” to a value of “0”. This means that above the limit of 26 km/h, no assistance is provided to the driver by a motor torque of the motor. In an intermediary range, that is, in the range from 23 to 26 km/h, the assistance of the rider by the motor is reduced in linear fashion. Assistance characteristic curves 20 of this kind are described in the related art. According to the present invention, the motor torque and here therefore also the assistance factor are ascertained on the basis of the filtered speed signal 12, however, and not based on the speed signal, which was initially detected by the sensor. This has the effect that in a continuous propulsion of the electric bicycle 1, signal components are removed from speed signal 10 that would result in a selection of assistance factor S, which may be experienced as uncomfortable.

FIG. 4 shows a signal flow chart, by which method 100 may be implemented accordingly. Thus, FIG. 4 shows that the speed signal 10 is provided on the input side. Speed signal 10 was detected by a sensor, for example. The speed signal 10 is provided directly to filter unit 11, which is a low-pass filter. In parallel, a derivation of speed signal 10 is formed in order to ascertain the dynamics of speed signal 10. In this example, the speed v written by speed signal 10 is transformed into acceleration a. Based on the acceleration a, the filter parameter T is calculated in a calculation electronics system 13 from the acceleration a. In the process, filter parameter T is calculated dynamically. Filter parameter T may also be designated a filter constant. The filter parameter T is supplied to filter unit 11 and a filter characteristic of the filter unit 11 is adjusted. The speed signal 10 is filtered in accordance with the selected filter characteristic of filter unit 11 and is provided by filter unit 11 on the output side. The filtered speed signal 12 is used to calculate an assistance factor S.

Thus, for example, an ascertainment unit 14 reads out the assistance factor S from the assistance characteristic curve shown in FIG. 3. The motor torque of the motor of the electric bicycle 1 is adjusted in accordance with the read-out assistance factor S. The motor torque is calculated for example from the bicycle torque, the assistance factor F and the factor of a speed cut-off.

With the aid of method 100, a uniform assistance of the rider at the cut-off limit is thus achieved even in the event of slight fluctuations in the speed signal.

In some situations, a simple and non-dynamic low-pass filtering of the speed signal will also result in a uniform assistance of the rider at the cut-off limit. However, the associated phase delay of the signal results in a delayed suspension of the assistance. Adherence to the regulatory norms is therefore not possible. For this reason, a concept including a dynamic low-pass filtering of the speed signal is created by method 100.

For this purpose, filter constant T of the low-pass filter varies in accordance with the dynamics of speed signal 10. The following behavior is to be achieved:

a) In the case of high dynamics of the speed signal (intense acceleration or braking processes), no or little filtering of speed signal 10.

b) In the case of no or low dynamics of the speed signal 10 (constant travel), strong filtering of the speed signal 10.

The speed signal 10 is filtered using filter constant T. This is limited to Tmax (maximum filtering) and Tmin (no filtering). An acceleration level is calculated from the speed signal. Above a specific acceleration level aₗᵢₘᵢₜ, it is always the case that T=Tmin. This ensures that the regulatory provisions are maintained for great accelerations at the cut-off limit and that in the event of intense braking above the cut-off limit, the assistance sets in again as quickly as possible.

Below aₗᵢₘᵢₜ, the filter constant T is varied dynamically. At a low acceleration level, the filter constant rises over time, at a higher acceleration level, the filter constant falls over time. During uniform rides, this results in a smoother speed signal 10 and thus results in a more uniform assistance of the rider at the cut-off limit.

In addition to the above written disclosure, explicit reference is made to the disclosure of FIGS. 1 through 4.

What is claimed is:

1. A method for adjusting a motor torque of a motor of an electric bicycle, comprising the following steps:
detecting a speed signal, which describes a speed of the bicycle;
selecting a filter parameter for a filter unit based on dynamics of the speed signal;
filtering the speed signal by the filter unit by applying the selected filter parameter; and
ascertaining a motor torque based on the filtered speed signal.

2. The method as recited in claim 1, wherein the dynamics of the speed signal are described by an acceleration of the bicycle.

3. The method as recited in claim 1, wherein the filter unit includes a low-pass filter.

4. The method as recited in claim 1, wherein the filter parameter is selected in such a way that the speed signal is filtered to a lesser degree in a case of a first dynamics than in a case of a second dynamics, the first dynamics being greater than the second dynamics.

5. The method as recited in claim 1, wherein, above a predefined first dynamics limit value, the filter parameter is set to a minimum value, at which, for the filter unit, a minimal filtering or no filtering of the speed signal occurs.

6. The method as recited in claim 1, wherein the filter parameter is selected as a function of an acceleration of the bicycle in such a way that
a degree of filtering of the speed signal rises over time when the acceleration is below a second dynamics limit value; and
a degree of filtering of the speed signal falls over time when the acceleration is above the second dynamics limit value.

7. The method as recited in claim 6, wherein the first dynamics limit value corresponds to a higher acceleration than the second dynamics limit value.

8. The method as recited in claim 1, wherein in the ascertainment of the motor torque based on the filtered speed signal, the motor torque is ascertained based on an assistance characteristic curve.

9. The method as recited in claim 8, wherein the assistance characteristic curve defines an assistance factor over a speed.

10. A device for adjusting a motor torque of a motor of an electric bicycle, the device configured to:
detect a speed signal, which describes a speed of the bicycle;
select a filter parameter for a filter unit based on a dynamics of the speed signal;
filter the speed signal by the filter unit by applying the selected filter parameter; and
ascertain a motor torque based on the filtered speed signal.
